(19) United States
(12) Patent Application Publication
(10) Pub. No.: US 2005/0169378 A1
(43) Pub. Date: Aug. 4, 2005

(54) Memory access method and memory access device

(75) Inventors: So-young Kim, Seoul (KR); Sung-Kyu Choi, Bucheon-si (KR); Jae-hun Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon City (KR)

(21) Appl. No.: 11/043,041

(22) Filed: Jan. 27, 2005

(30) Foreign Application Priority Data
Jan. 31, 2004 (KR) 2004-6468

(51) Int. Cl. H04N 7/12

(52) U.S. Cl. 375/240.16; 375/240.12; 375/240.24

(57) ABSTRACT

A memory access method and a memory access device are provided. The memory access method for performing motion compensation includes obtaining reference picture data corresponding to a bounding box from an external memory in units of bounding boxes, the bounding box includes a group of predetermined partitions among partitions in a macroblock to be motion-compensated. According to the method and device, the amount of memory access required for motion compensation in a video decoder can be reduced.

### CROSS-REFERENCE TO RELATED APPLICATIONS

This application claims the benefit of Korean Patent Application No. 2004-6468, filed on Jan. 31, 2004, in the Korean Intellectual Property Office, the disclosure of which is incorporated herein by reference.

### BACKGROUND OF THE INVENTION

1. Field of the Invention

The present invention relates to a memory access method, and more particularly, to a memory access method and apparatus for motion compensation of video data.

2. Description of the Related Art

A multimedia system requires a large system bus bandwidth because of a large amount of data to be processed in real time. In a video decoder, memory access required for motion compensation and display utilizes most of the bandwidth. Recently, H.264 has been proposed as an international standard for moving picture encoding, and therefore, motion estimation and compensation have become more complex than in previous methods such that the amount of memory access required for motion compensation has increased compared to that of the previous methods.

In H.264, a variety of motion compensation block sizes are provided within a range of from 16×16 to 4×4 luminance samples. The luminance component of each macroblock formed with 16×16 samples can be divided in four types as shown in FIGS. 1A through 1D. Each of the divided areas is referred to as a macroblock partition.

FIGS. 1A through 1D show a variety of prediction modes macroblock partitions of H.264 according to the conventional technology.

FIG. 1A shows one or a single macroblock partition formed with 16×16 samples, FIG. 1B shows two macroblock partitions formed with 16×8 samples, FIG. 1C shows two macroblock partitions formed with 8×16 samples, and FIG. 1D shows four macroblock partitions formed with 8×8 samples.

When an 8×8 macroblock partition mode is selected, each of four 8×8 macroblock partitions in the macroblock can be divided into four types as shown in FIGS. 2A through 2D. Each of the divided areas is referred to as a sub-macroblock partition.

FIG. 2A shows one sub-macroblock partition formed with 8×8 samples, FIG. 2B shows two sub-macroblock partitions formed with 8×4 samples, FIG. 2C shows two sub-macroblock partitions formed with 4×8 samples, and FIG. 2D shows four sub-macroblock partitions formed with 4×4 samples.

These partitions and sub-partitions may be constructed in a variety of combinations in each macroblock. Also, a separate motion vector for each partition or sub-partition is required. Generally, in a homogeneous area of a frame, a partition of a large size is appropriate, while in a detailed area, a partition of a small size is appropriate.

FIG. 3A shows an example of motion vectors in a macroblock, and FIG. 3B shows data to be obtained from a reference picture according to the example of motion vectors shown in FIG. 3A.

Referring to FIG. 3A, the motion vectors for all partitions in the macroblock are identical. In this case, all partitions in the macroblock are contiguous as shown in FIG. 3B, such that data can be obtained more efficiently.

FIG. 4A shows another example of motion vectors in a macroblock, and FIG. 4B shows data to be obtained from a reference picture according to the example of motion vectors shown in FIG. 4A.

Referring to FIG. 4A, all partitions in the macroblock include motion vectors of 4×4 units different from each other. In this case, data for each 4×4 partition should be obtained as shown in FIG. 4B, such that the amount of data obtained at one time is small and the frequency of bus access greatly increases.

In a video decoder, in order to perform motion compensation, data should be obtained from a corresponding reference picture. Since this reference picture has a large amount of data, it is stored in an external memory such as a Synchronous Dynamic Random Access Memory (SDRAM) and by accessing a bus, the reference picture stored in the external memory should be read and obtained.

FIG. 5 is a diagram showing an access protocol to obtain a reference picture from an external memory.

In order to read and obtain data in an external memory, a request signal, the memory address of data desired to be accessed, and a signal (i.e. burst) indicating how many data items contiguous to the address should be obtained are transmitted.

Referring to FIG. 5, when a Direct Memory Access (DMA) sends a request signal to the external memory at the first clock signal, the external memory sends a grant signal at the second clock, the DMA sends a control signal to read data and address data at the next clock, and then the external memory transmits read data and a transmission signal to the DMA.

In case of a SDRAM, clock cycles required for reading out data in contiguous locations are few when using a burst mode, however when reading discontinuous data many clock cycles are needed because a request signal and address data should be sent each access time.

When a motion is compensated, a corresponding partition should be obtained from a reference picture. When partitions are formed by dividing a macroblock into smaller pieces, data required for each partition should be obtained and accordingly the number of partitions to be motion compensated increases.

The size of reference picture data is such that when it is implemented by hardware, the reference picture data are stored in an external memory and when needed, only required data is obtained through a bus and utilized. At this time, data of contiguous addresses can be obtained using a bus by one request, but data of discontinuous addresses should be obtained by requesting the bus several times. In order to efficiently use the bus to provide a variety of data, it is necessary to obtain required data with less number of accesses.

When the prediction modes are divided into more detailed pieces, the location of each partition that should be obtained varies. Accordingly, when data in the memory is obtained using the bus, the amount of data that is obtained at one time decreases and the frequency of bus access increases. This makes the use of the bus inefficient and causes a bottle neck on the entire hardware decoder.

For example, when it is assumed that all 4×4 partitions in a macroblock have motion vectors different from each other and the motion vector of each partition is not an integer pel, for each partition a reference partition of a 9×9 size (including neighboring data for interpolation) should be obtained. In order to separately access and obtain each of these reference partitions, the length of data required to be requested at a time is 9 bytes (when one burst is 4 bytes, the burst length is 3) and the frequency of requesting the bus for data is 9*16=144 times.

As another example, when a macroblock is in a 16×16 mode and is not divided into partitions and the motion vector is an integer pel, only obtaining a 16×16 partition from the reference picture is needed. Accordingly, the length of data required to be requested at a time is 16 bytes (the burst length is 4 or 5), and the frequency for requesting the bus for data is 16 times.

The following two examples show extreme cases. When data is coded using an H.264 encoder, in most cases, when a bit rate is high, a mode in which partitions are formed by dividing a macroblock into smaller pieces, are frequently selected, and when a bit rate is low, the mode is not frequently selected. Meanwhile, as a prediction mode is divided into smaller pieces, the location of each partition that should be obtained varies. Accordingly, when data in the memory is obtained using the bus, the amount of data that is obtained at one time decreases and the frequency of bus access increases. This makes the use of the bus inefficient and causes a bottle neck on the entire hardware decoder.

For example, in H.264, all 4×4 partitions in a macroblock may include motion vectors which are different from each other. When the motion vector of each partition is not an integer pel, for each partition a reference partition of a 9×9 size (including neighboring data for interpolation) should be loaded. In order to separately access and obtain each of the reference partitions, the length of data, required to be requested at a time is 9 bytes (when one burst is 4 bytes, the burst length is 3) and the frequency of requesting the bus for data is 9*16=144 times. When the width of a bus is 32 bits and a minimum delay between two accesses is 5 clocks, and when requests are sent and data is received in the most efficient way is assumed, then the total number of required clock cycles is (3×144)+(5×143)=1147.

Meanwhile, when the conventional method performing motion compensation in units of half pels in a 16×16 macroblock unit is considered, required data are 17×17 and therefore the burst length is 5, while the access frequency is 17 and therefore (5×17)+(5×16)=165 clocks are required.

That is, it can be seen that in H.264, the number of clocks required for motion compensation has increased about seven times that of the previous video codec. Accordingly, a method capable of more efficiently using a bus is needed.

### SUMMARY OF THE INVENTION

Accordingly, it is an aspect of the present invention to provide a memory access method and memory access device capable of reducing the amount of memory access required when motion compensation is performed in a video decoder.

Additional aspects and/or advantages of the invention will be set forth in part in the description which follows and, in part, will be obvious from the description, or may be learned by practice of the invention.

The foregoing and/or other aspects of the present invention are achieved by providing a memory access method for performing motion compensation of video data including obtaining reference picture data corresponding to a bounding box from an external memory in units of bounding boxes, wherein the bounding box includes a group of predetermined partitions among partitions in a macroblock to be motion-compensated.

The obtaining of the reference picture data may include examining a motion vector of each partition in the macroblock, determining whether to generate a bounding box having predetermined partitions based on the examination result, generating a bounding box according to the determination, and accessing and obtaining reference picture data corresponding to the generated bounding box in the external memory.

The determining whether to generate a bounding box may include generating a bounding box, when a similarity of the motion vectors is equal to or higher than a predetermine reference. The predetermined reference may be determined by considering at least one of a frequency of external memory access and a size of an internal memory.

The generating a bounding box according to the determination may include, determining a location and size of the bounding box by referring to motion vectors forming the bounding box, or grouping partitions having similar motion vectors and generating at least one bounding box.

The method may further include determining to use partitions, when a similarity of the motion vectors are lower than a predetermined reference, determining a location and size of data according to the partitions based upon the determination, and accessing and obtaining reference picture data corresponding to the partitions in the external memory and.

It is another aspect of the present invention, to provide a memory access device for performing motion compensation of video data including a processing unit which performs processing such that reference picture data corresponding to a bounding box is obtained from an external memory in units of bounding boxes, wherein the bounding box includes a group of predetermined partitions among partitions in a macroblock to be motion-compensated.

The processing unit may include a motion vector examining unit which examines a motion vector of each partition in the macroblock, and based on the examination result, determines whether to generate a bounding box having predetermined partitions, a bounding box determination unit which generates a bounding box according to the determination, and a memory access unit which accesses and obtains reference picture data corresponding to the generated bounding box in the external memory.

### BRIEF DESCRIPTION OF THE DRAWINGS

These and/or other aspects and advantages of the invention will become apparent and more readily appreciated from the following description of the embodiments taken in conjunction with the accompanying drawings in which:

FIGS. 1A through 1D are diagrams showing a variety of prediction modes of H.264 according to the conventional technology;

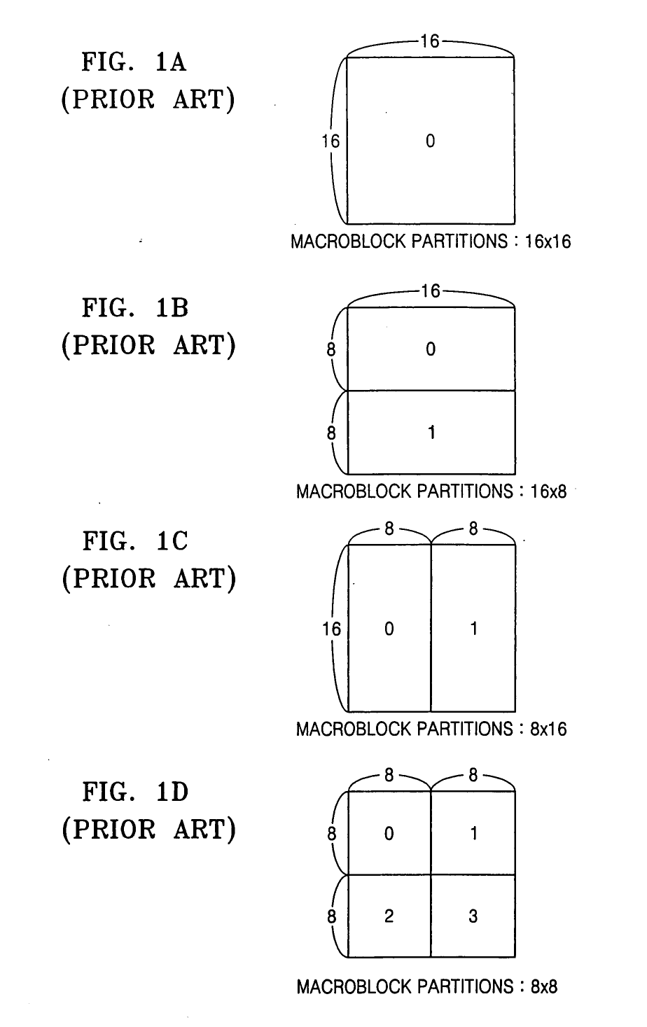

FIGS. 2A through 2D are diagrams showing a variety of prediction modes of H.264 according to the conventional technology;

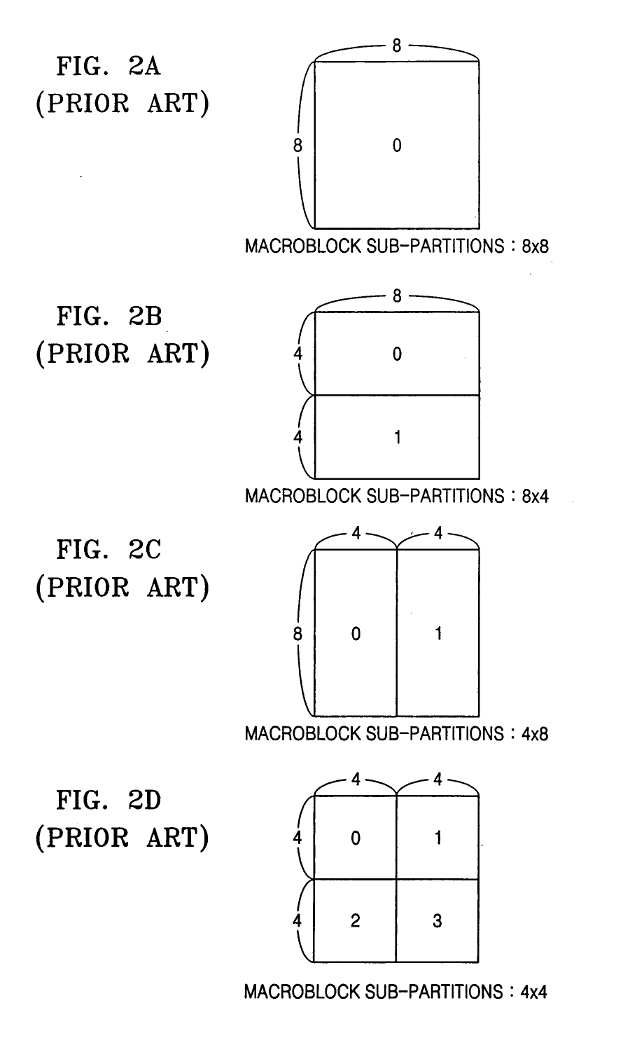

FIG. 3A shows an example of a motion vector in a macroblock, and FIG. 3B shows data to be obtained from a reference picture according to the example of a motion vector shown in FIG. 3A;

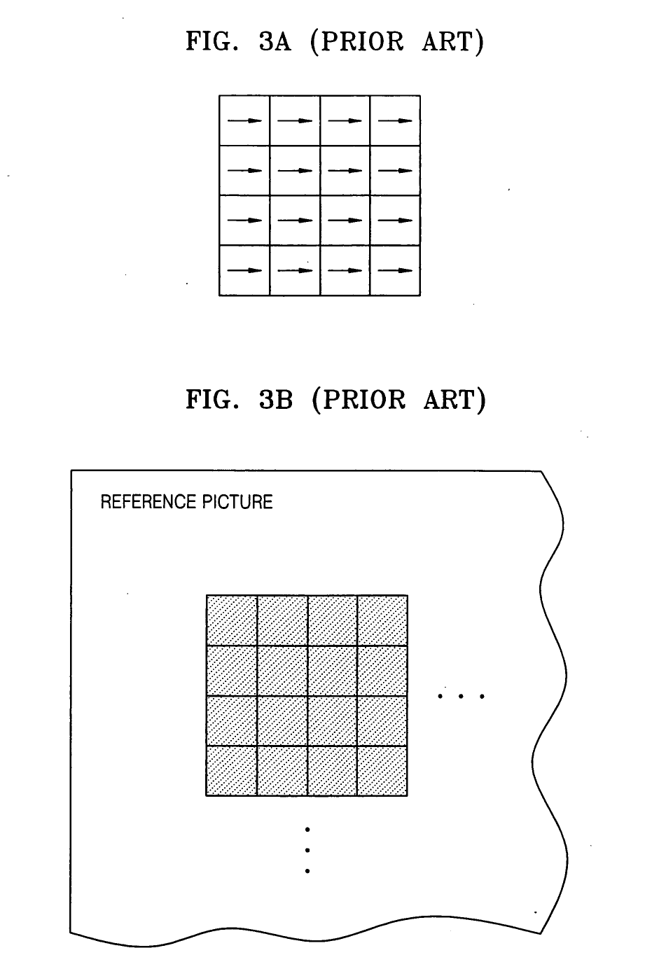

FIG. 4A shows another example of a motion vector in a macroblock, and FIG. 4B shows data to be obtained from a reference picture according to the example of a motion vector shown in FIG. 4A;

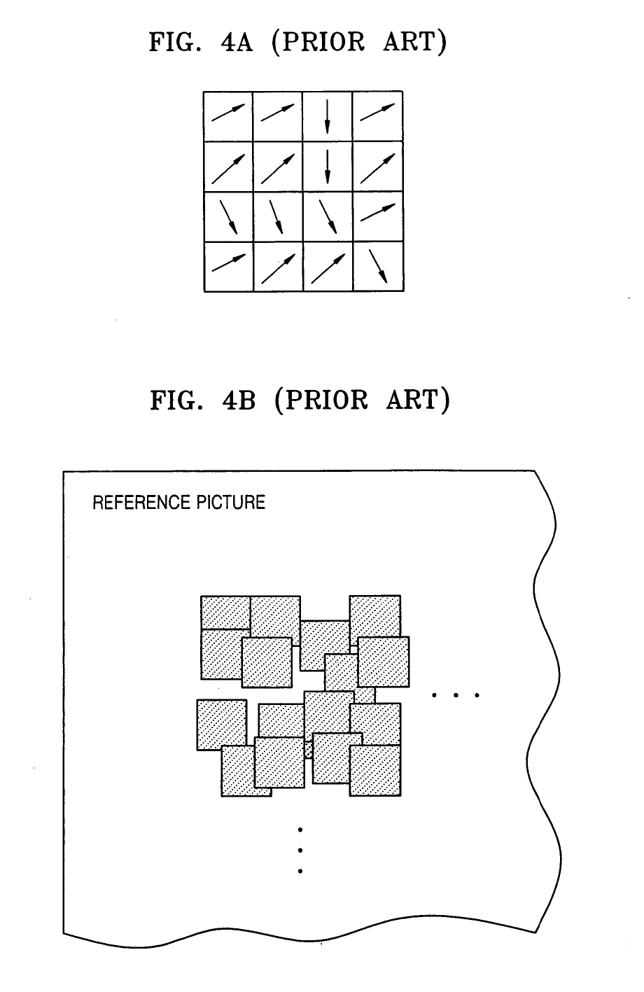

FIG. 5 is a diagram showing an access protocol to obtain a reference picture from an external memory;

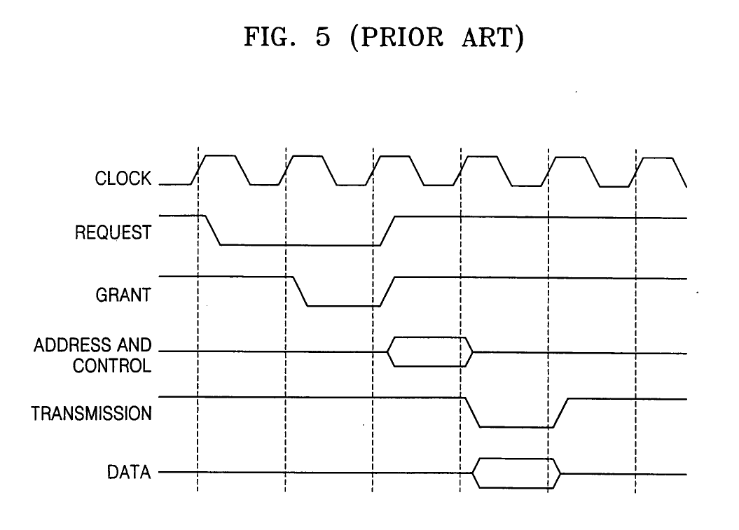

FIG. 6 is a schematic block diagram of a video decoder according to the present invention;

FIG. 7 is a block diagram showing a detailed structure of a DMA shown in FIG. 6;

FIG. 8 is a reference diagram to explain an example of a bounding box according to the present invention;

FIG. 9 is a reference diagram to explain another example of a bounding box according to the present invention;

FIG. 10 is a flowchart illustrating a method for accessing data in an external memory for motion compensation according to an embodiment of the present invention; and

FIG. 11 is a reference diagram showing experiment results to compare the performance of the present invention with that of the conventional technology.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

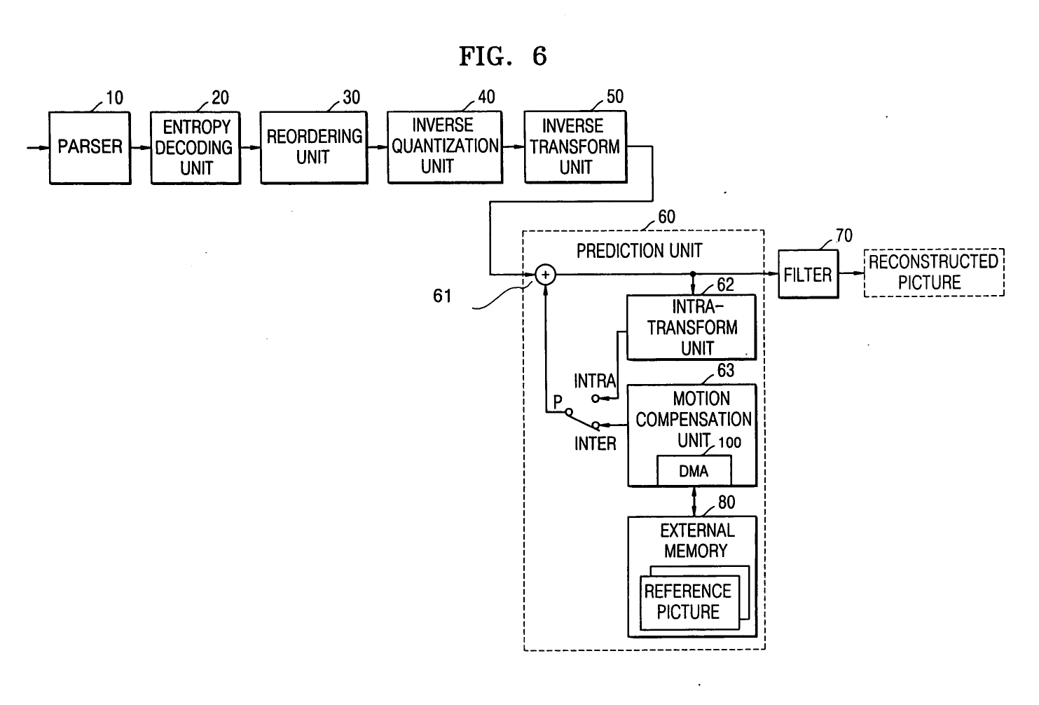

Referring to FIG. 6, a video decoder according to the present invention includes a parser 10, an entropy decoding unit 20, a reordering unit 30, an inverse quantization unit 40, an inverse transform unit 50, a prediction unit 60, a filter 70, and an external memory 80.

The parser 10 receives and parses a compressed bit stream from a network layer.

The entropy decoding unit 20 receives the parsed data from the parser 10, and entropy decodes the data. The reordering unit 30 arranges the entropy decoded data.

The inverse quantization unit 40 inverse quantizes the arranged data to generate quantized coefficients, and the inverse transform unit 50 inverse transforms the quantized coefficients.

The prediction unit 60 generates a decoded macroblock by using header information decoded from the bit stream received from the inverse transform unit 50. The filter 70 filters data received from the prediction unit 60 and forms a reconstructed picture.

The prediction unit 60 includes an addition unit 61, an intra prediction unit 62, and a motion compensation unit 63. The addition unit 61 adds prediction macroblock P output from the motion compensation unit 63 to the data output from the inverse transform unit 50. The intra prediction unit 62 performs intra prediction, and the motion compensation unit 63 performs motion compensation by referring to a reference picture stored in the external memory 80. At this time, since the data amount of the reference picture is large, the reference picture is stored in the external memory 80, and the DMA 100 of the motion compensation unit 63 obtains reference picture data in units of predetermined amounts, from the external memory 80. In particular, in order to use a bus more efficiently, the DMA 100 according to the present invention access a data block having a group of one or more partitions.

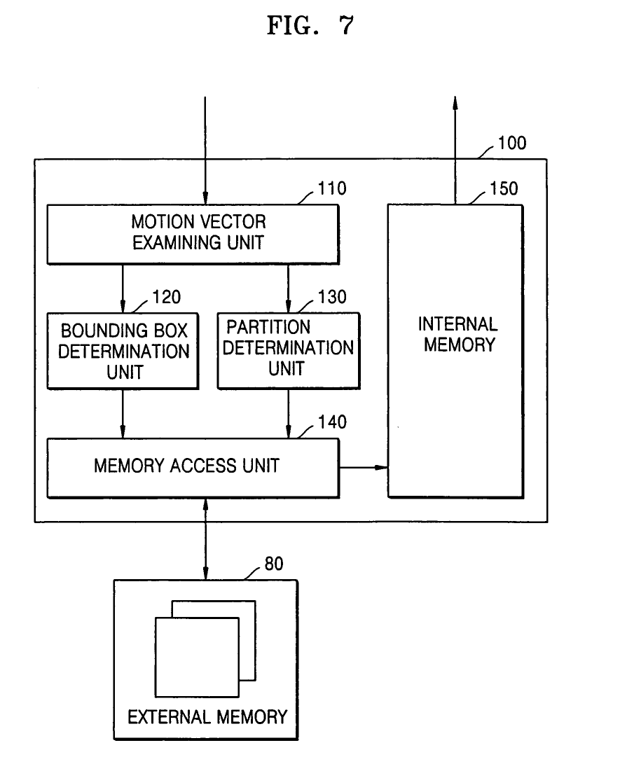

That is, based on a predetermined reference, the DMA 100 according to the present invention, groups partitions having similar motion vectors into one bounding box, and accesses the amount of data that are determined by the bounding box, in the external memory. Here, the predetermined reference corresponds to a maximum size of the bounding box. This DMA 100 will now be explained with reference to FIG. 7.

FIG. 7 is a block diagram showing a detailed structure of the DMA shown in FIG. 6.

Referring to FIG. 7, the DMA 100 includes a motion vector examination unit 110, a bounding box determination unit 120, a partition determination unit 130, a memory access unit 140, and an internal memory 150.

The motion vector examination unit 110 examines the motion vector of each partition in a macroblock. That is, the motion vector examination unit 110 examines a similarity of motion vectors in respective partitions, and when the similarity of motion vectors are higher than a predetermined reference, makes partitions having the motions vectors with similarity higher than a predetermined reference, a group (referred to as “a bounding box”), and obtains the group from the external memory 80. As mentioned above, the predetermined reference corresponds to a maximum size of the bounding box. More specifically, the similarity of motion vectors corresponds to the similarity of positions of partitions in a reference picture to be obtained by the motion vectors. That is, the size of data configured by positions of partitions in a reference picture to be obtained by the motion vectors in a macroblock is not larger than the maximum size of the bounding box, it is determined to generate a bounding box. Thus, when the motion vectors are similar to each other, accordingly, the size of data to be obtained by these motion vectors is not larger than the predetermined reference (i.e., the maximum size of the bounding box), therefore generation of the bounding box is determined. However, when the motion vectors are not similar to each other, accordingly, the size of data to be obtained by these motion vectors is larger than the predetermined reference, therefore, it is determined not to generate the bounding box.

At this time, the maximum size of the bounding box is determined in consideration of, for example, the frequency of bus access and the size of the internal memory 150. For example, through experiments, when the number of cases in which size of data to be obtained by motion vectors in a macroblock is below 40×36, and higher than approximately 95%, it is determined that the maximum size of the bounding box is 40×36. Further, the maximum size of the bounding box is determined in consideration of the size of the internal memory 150 storing data obtained from the external memory 80.

When the size of data configured by positions of partitions in a reference picture to be obtained by the motion vectors in a macroblock is larger than the maximum size of bounding box, the motion vector examination unit 110 determines to obtain data for each partition from the external memory 80. That is, when the motion vectors of 4×4 partitions are too different from each other and the motion vector examination unit 110 determines that separately obtaining data required for each partition is more advantageous than obtaining data after generating a bounding box, it determines to obtain data for each partition from the external memory 80.

When as the result of examination by the motion vector examination unit 110, it is determined that data is obtained in units of bounding boxes, the bounding box determination unit 120 calculates the location of a bounding box and determines the size of the bounding box.

When as the result of examination by the motion vector examination unit 110, it is determined that data is obtained in units of partitions, the partition determination unit 130 calculates the location of data required for each partition, and determines the size of data required for each partition.

According to a command from the bounding box determination unit 120 or the partition determination unit 130, the memory access unit 140 accesses the external memory 80, obtains data determined by a bounding box or a partition, and stores the data obtained from the external memory 80 in the internal memory 150.

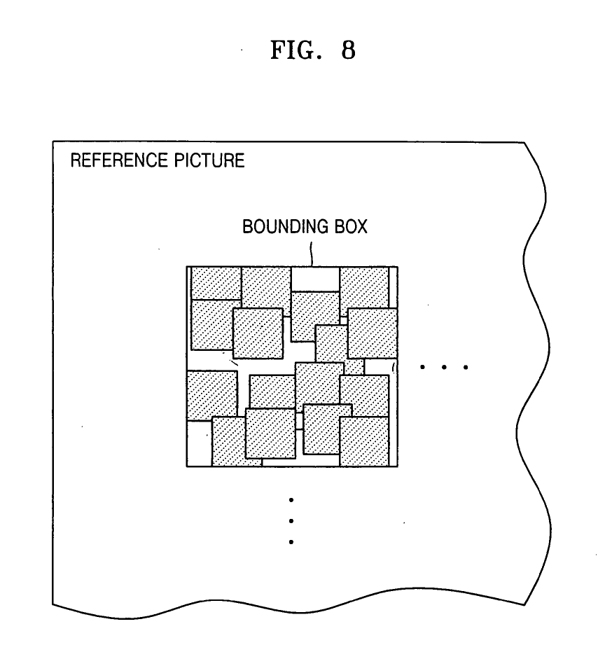

FIG. 8 is a reference diagram used to explain an example of a bounding box according to the present invention.

In FIG. 8, the motion vector of each of 4×4 partitions is not an integer pel and is different from each other. Each square in the bounding box shown in FIG. 8 is a 9×9 reference sample for motion compensation of one of 4×4 partitions. When data required for motion compensation are distributed as shown in FIG. 8, obtaining a group of data packed in a bounding box as shown in FIG. 8 is more advantageous than separately obtaining each 9×9 data sample in terms of bus access.

When each 9×9 data sample is separately obtained, the required frequency of bus access is 9×16=144 times, and the data amount obtained at one time for each access is 9 bytes. At this time, the total number of required clocks is (3×144)+(5×143)=1147. Meanwhile, when a bounding box is obtained (for example, assuming that the width of the bounding box is 40 bytes and the height is 30 bytes), the frequency of required bus access is 36 times, and the data amount obtained at one time for each access is 40 bytes. At this time, the total number of required clocks is (10×30)+(5×29)=445. The latter is more advantageous in terms of bus access.

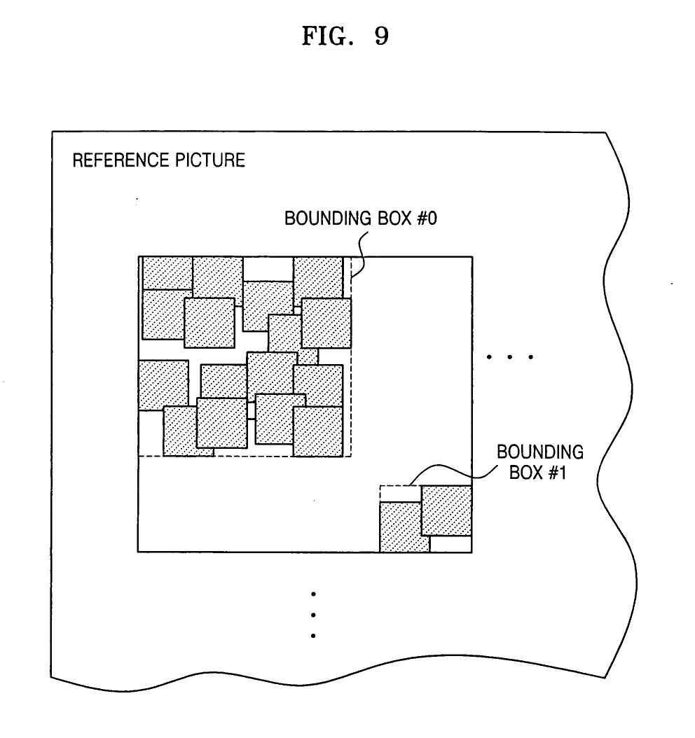

FIG. 9 is a reference diagram to explain another example of a bounding box according to the present invention. Referring to FIG. 9, when desired data corresponding to partitions are concentrated in two part of a macroblock, the macroblock can be divided into two groups of bounding box #0 and bounding box #1 centered at respective concentrated parts, to thereby avoid obtaining unnecessary data. Thus, the efficiency can be lowered.

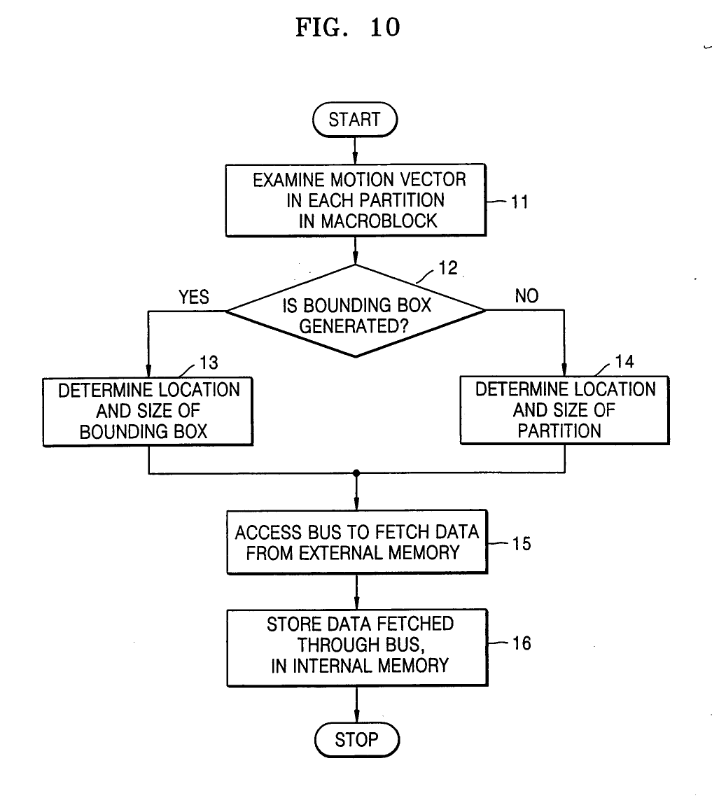

FIG. 10 is a flowchart illustrating a method for accessing data in an external memory for motion compensation according to an embodiment of the present invention.

Referring to FIG. 10, at operation 11, a motion vector examination unit examines the motion vector of each partition in a macroblock desired to be motion compensated. That is, the motion vector examination unit 110 examines the similarity of motion vectors, compares the similarity with a predetermined reference, and the process moves to operation 12, where the motion vector examination unit determines whether to generate a bounding box.

In operation 12, when the comparison result indicates that generating a bounding box is more advantageous in operation 12, the process then moves to operation 13, where a bounding box determination unit determines the location and size of a bounding box. The size of the bounding box is determined based upon the size of data to be obtained by the motion vectors.

In operation 12, when the comparison result indicates that generating a bounding box is not advantageous, the process then moves to operation 14, where a partition determination unit determines the location and size of a data item required for each partition in operation 14.

When a bounding box or a partition is determined in operation 13 and 14 respectively, the process then moves to operation 15, where a memory access unit accesses a bus to obtain data from an external memory. That is, the memory access unit obtains a predetermined amount of data corresponding to the bounding box or the partition determined as above, from the location of a reference picture stored in the external memory.

From operation 15, the process moves to operation 16, where data obtained through a bus is stored in an internal memory.

According to the present invention as described above, the frequency of bus access to access an external memory can be reduced and the length of data obtained from the external memory at one access is increased such that the efficiency of the bus can be improved.

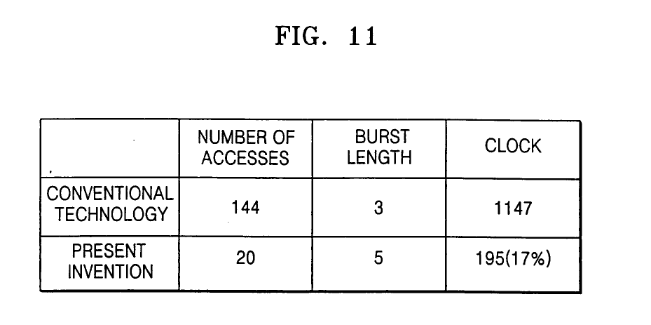

FIG. 11 is a reference diagram showing experiment results to compare the performance of the present invention with that of the conventional technology.

The experiment result of using the method of the present invention will now be explained. In the experimental test, H.264 video codec was utilized.

In the test results with a foreman CIF size image sequence, when Q value (i.e., quantization parameter) was set to 30, the average frequency of bus access was 20, and the burst number (4 byte unit) to be accessed at one time was 5. When Q value was set to 10, the average frequency of bus access was 21, and the burst number (4 byte unit) to be accessed at one time was 6. The less Q value is, the more frequently the mode is divided into smaller pieces. The results show that obtaining data in a bounding box according to the present invention is very efficient. Also, the results of the present invention are better than the results when using the conventional method by which the frequency of bus access was 144 and the burst number to be accessed at one time was 3. Thus, all the experiment results show that the present invention is practically more efficient. Furthermore, when experiments were performed by changing access ranges for a plurality of sequences, the cases where the width of a bounding box exceeds 40 bytes (burst 10) or the height is equal to or greater than 30 bytes for a CIF size image sequence, recorded less than 0.5%.

Although a few embodiments of the present invention have been shown and described, it would be appreciated by those skilled in the art that changes may be made in these embodiments without departing from the principles and spirit of the invention, the scope of which is defined in the claims and their equivalents.

1. A memory access method for performing motion compensation of video data, comprising:
obtaining reference picture data corresponding to a bounding box from an external memory in units of bounding boxes, wherein the bounding box includes a group of predetermined partitions among partitions in a macroblock to be motion-compensated.

2. The method of claim 1, wherein the obtaining of the reference picture data comprises:
examining a motion vector of each partition in the macroblock;
determining whether to generate a bounding box having predetermined partitions based on the examination result;
generating a bounding box according to the determination; and
accessing and obtaining reference picture data corresponding to the generated bounding box in the external memory.

3. The method of claim 2, wherein the determining whether to generate a bounding box comprises:
generating a bounding box, when a similarity of the motion vectors is equal to or higher than a predetermine reference.

4. The method of claim 3, wherein the predetermined reference is determined by considering at least one a frequency of external memory access and a size of an internal memory.

5. The method of claim 2, wherein the generating a bounding box according to the determination comprises:
determining a location and size of the bounding box by referring to motion vectors forming the bounding box.

6. The method of claim 2, wherein the generating a bounding box according to the determination comprises:
grouping partitions having similar motion vectors and generating at least one bounding box.

7. The method of claim 2, further comprising:
determining to use partitions, when a similarity of the motion vectors are lower than a predetermined reference;
determining a location and size of data according to the partitions according to the determination; and
accessing and obtaining reference picture data corresponding to the partitions in the external memory.

8. A memory access device for performing motion compensation of video data, comprising:
a processing unit which performs processing such that reference picture data corresponding to a bounding box is obtained from an external memory in units of bounding boxes, wherein the bounding box includes a group of predetermined partitions among partitions in a macroblock to be motion-compensated.

9. The device of claim 8, wherein the processing unit comprises:
a motion vector examining unit which examines a motion vector of each partition in the macroblock, and based on the examination result, determines whether to generate a bounding box having predetermined partitions;
a bounding box determination unit which generates a bounding box according to the determination; and
a memory access unit which accesses and obtains reference picture data corresponding to the generated bounding box in the external memory and obtains the reference picture data.

10. The device of claim 9, wherein when a similarity of the motion vectors is equal to or higher than a predetermine reference, the motion vector examining unit determines to generate a bounding box.

11. The device of claim 10, wherein the predetermined reference is determined by considering at least one of a frequency of external memory access and a size of an internal memory.

12. The device of claim 9, wherein the bounding box determination unit determines a location and size of the bounding box, by referring to motion vectors forming the bounding box.

13. The device of claim 9, wherein the bounding box determination unit groups partitions having similar motion vectors and generates at least one bounding box.

14. The device of claim 9, further comprising:
a partition determination unit wherein when the motion vector examination unit determines to use partitions when a similarity of the motion vectors are lower than a predetermined reference, and according to the determination, the partition determination unit determines a location and size of data according to the partitions, wherein the memory access unit accesses and obtains reference picture data corresponding to the partitions in the external memory.

15. The method of claim 1, wherein when the predetermined partitions to be motion-compensated are concentrated in separate parts of the macroblock, generating a bounding box corresponding to each of the concentrated parts of the macroblock.
